(19) United States
(12) Patent Application Publication
(10) Pub. No.: US 2026/0167809 A1
(43) Pub. Date: Jun. 18, 2026

(54) HEMP POLYMER COMPOUNDS WITH AN ADDITIVE AND METHODS OF MAKING SAME

(71) Applicant: The Hemp Plastic Company, Boulder, CO (US)

(72) Inventors: KEVIN TUBBS, WASILLA, AK (US); FRANCINE ETTENSON, BOULDER, CO (US); PAUL BENHAIM, MULLUMBIMBY, NSW (AU); GREG DEAN, CANTON, MI (US)

(21) Appl. No.: 19/381,463

(22) Filed: Nov. 6, 2025

Related U.S. Application Data
(63) Continuation of application No. 17/754,284, now abandoned.
(60) Provisional application No. 62/908,322, filed on Sep. 30, 2019.
(60) Provisional application No. 62/908,360, filed on Sep. 30, 2019.
(60) Provisional application No. 62/908,339, filed on Sep. 30, 2019.
(60) Provisional application No. 62/908,351, filed on Sep. 30, 2019.
(60) Provisional application No. 62/908,369, filed on Sep. 30, 2019.

(51) Int. Cl. C08L 23/06; C08J 3/12; C08J 5/18; C08L 5/08; C08L 9/06; C08L 23/12; C08L 67/04; C08L 97/02; C08L 101/16

(52) U.S. Cl. CPC C08L 23/06; C08J 3/12; C08J 5/18; C08L 5/08; C08L 9/06; C08L 23/12; C08L 67/04; C08L 97/02; C08L 101/16; C08J 2305/08; C08J 2323/12; C08J 2497/02; C08L 2201/08; C08L 2203/02; C08L 2203/30; C08L 2205/025; C08L 2205/08

(57) ABSTRACT

The present invention relates to polymer compounds containing hemp and methods for producing such polymer compounds. More specifically, the invention relates to such hemp-containing polymer compounds containing one or more property-enhancing additives.

### CROSS REFERENCE TO RELATED APPLICATIONS

The present is application is a continuation application of U.S. application Ser. No. 17/754,284 filed on Mar. 29, 2022, which is a U.S. National State entry under U.S.C. 371 of International Application No. PCT/US2020/053291, filed Sep. 29, 2020, designating the United States of America and published in English on Apr. 8, 2021, which in turn claims priority to U.S. Provisional Application No. 62/908,322, filed Sep. 30, 2019; U.S. Provisional Application No. 62/908,360, filed on Sep. 30, 2019; U.S. Provisional Application No. 62/908,339, filed on Sep. 30, 2019; U.S. Provisional Application No. 62/908,351, filed on Sep. 30, 2019; and U.S. Provisional Application No. 62/908,369, filed on Sep. 30, 2019. The entire contents of each of the foregoing are hereby incorporated by reference herein.

### BACKGROUND

### Field

The invention disclosed herein generally relates to polymer compounds containing hemp and methods for producing such polymer compounds. More specifically, the invention relates to such hemp-containing polymer compounds containing one or more property-enhancing additives.

### Background

Thermoplastics and other polymer compounds are used to produce a wide variety of consumer and industrial goods. Such polymers are derived from petroleum, and concern has arisen over the environmental impact of the extraction of petroleum, the processing of polymer compounds, and the disposal of the resultant plastic products. It is desirable to create compounds which are capable of serving the same role as petroleum plastic polymers and which are also sourced from sustainable, renewable, and environmentally friendly resources, including using material obtained from an extraction process.

### SUMMARY

The present invention relates to polymer compounds/materials containing hemp or hemp derivatives, which exhibit properties similar to those possessed by traditional petroleum plastics. The present invention further relates to plastic compositions containing one or more additives to enhance the plastic for a particular use, as well as methods of producing such hemp polymer compounds. Specific embodiments of the present invention can be formulated to deliver desired characteristics, such as antiblock; antifog; antimicrobial; antioxidant; antistat; antiwarp; clarification; colorant; conductivity promotion; conductivity reduction; cycle time reduction; density enhancement; density reduction; dimensional stability enhancement; flame retardation; foaming promotion; foaming reduction; friction promotion; friction reduction; heat stabilization; hydrophobicity enhancement; hydrophobicity reduction; impact modification; IR absorption; IR reflection; laser marking; mold release; nucleation; odor masking; optical brightening; polymer compatibility; polymer coupling; polymer processing enhancement; process-temperature lubrication; purge promotion; release promotion; resistance to acid and base; scent modification; scuff resistance; slip modification; stiffness enhancement; torque release; tracing; UV blocking; UV inhibition; UV stabilization; vapor corrosion inhibition; and/or the like.

Some embodiments of the invention relate to a hemp-based plastic composition including 5%-80% hemp material combined with a thermoplastic polymeric material and at least one additive selected to confer or enhance a property of the plastic.

In some embodiments, the property can be at least one of: antiblock; antifog; antimicrobial; antioxidant; antistat; antiwarp; clarification; colorant; conductivity promotion; conductivity reduction; cycle time reduction; density enhancement; density reduction; dimensional stability enhancement; flame retardation; foaming promotion; foaming reduction; friction promotion; friction reduction; heat stabilization; hydrophobicity enhancement; hydrophobicity reduction; impact modification; IR absorption; IR reflection; laser marking; mold release; nucleation; odor masking; optical brightening; polymer compatibility; polymer coupling; polymer processing enhancement; process-temperature lubrication; purge promotion; release promotion; resistance to acid and base; scent modification; scuff resistance; slip modification; stiffness enhancement; torque release; tracing; UV blocking; UV inhibition; UV stabilization; vapor corrosion inhibition; and/or the like.

In some embodiments, the hemp-based plastic composition can include between about 10-40% hemp material.

In some embodiments, the hemp material can be derived from one or more of parts of a hemp plant selected from seed, seed hull, seed powder, flower, stem, stalk, root, lignin, cellulose, shive/hurd, and/or the like.

In some embodiments, the hemp material can include particulate hemp material. In some embodiments, the particulate material can include particles between 1 micron and 1000 microns in size.

In some embodiments, the hemp material can have a moisture content between 0.25% and 15%.

In some embodiments, the thermoplastic polymeric material can be derived from a plant, animal or bacterium.

In some embodiments, the thermoplastic polymeric material is a thermoplastic resin. In some embodiments, the thermoplastic resin can be selected from polypropylene, polyethylene, acrylonitrile butadiene styrene, and/or the like.

In some embodiments, the composition can be in the form of a pellet or a sheet.

In some embodiments, the composition can be adapted to be suitable for at least one use selected from: injection-molded plastic; rotomold plastic; thermoformed plastic; form-extruded, blowmold plastic; straw plastic; film; nano hemp-graphene plastic; scratch and mar resistant plastic; antimicrobial plastic; hemp liquid natural resin; hemp natural adhesive; hemp textile polymer; 3D printer plastic; filament-extruded; enhanced biodegradable plastic; automotive plastic; aerospace plastic; foodservice plastic; outdoor/high impact resistant plastic; indoor/paintable plastic; post-consumer resin plastic; and/or the like. In some embodiments, the at least one additive can enhance the suitability.

In some embodiments, the hemp-based plastic composition can have a Hemp Plastic Comparability Quotient (HPCQ) of less than 3. In some embodiments, the hemp-based plastic composition can have a HPCQ of less than 1.

In some embodiments, the HPCQ can be based on at least one of: Gardner impact resistance; melt flow rate; tensile elongation; tensile strength; density/specific gravity; melt mass-flow rate; molding shrinkage; flexural modulus; flexural strength; notched IZOD impact; Rockwell hardness; deflection temperature under load; flame rating; and/or the like.

Some embodiments of the invention relate to a method of making any of the compositions described herein. In some embodiments, the method can include combining a hemp material with a thermoplastic polymeric material and at least one additive, to create a polymeric base composition such that 1-80% of the composition is hemp material. In some embodiments, the method can include exposing the base composition to conditions selected from at least two of elevated heat; elevated pressure; combination with a fourth material; a molding, injecting, layering or extruding process; a finishing process; and/or the like. In some embodiments, the method can include and recovering the hemp-based plastic composition.

### DETAILED DESCRIPTION

The present invention relates to polymer materials made from hemp. Hemp can include any variants of the Cannabis plant, including but not limited to Cannabis sativa, Cannabis indica, and Cannabis ruderalis. Hemp can include any strains or varieties of any Cannabis plant, inclusive of varieties occurring naturally, varieties occurring in the wild, and varieties cultivated through human agricultural processes.

Currently in the United States “Industrial Hemp” is defined by Congress as being Cannabis sativa having a THC value below 0.3%. However, many botanists consider the distinction among the difference species designations to be flawed and treat all members of the genus Cannabis as variations on a single species, defaulting to Cannabis sativa. For purposes of this disclosure, hemp can refer to any plant of the genus Cannabis such that hemp fibers, hemp biomass, and the like can refer to materials from any Cannabis plant. The invention expressly contemplates these different embodiments and meanings of the term “hemp;” specific interpretation of which scope of “hemp” is meant in a given usage can be interpreted from context. Embodiments of the invention can also include as source material plants having hemp-like characteristics in terms of their fiber, parts, chemistry, growth habit, and the like. A non-limiting example of such a hemp-like plant is Kenaf (Hibiscus cannibinus).

In some embodiments, the polymer material can include a hemp material that includes individual parts or combinations of parts of the hemp plant or any derivative of the hemp plant. The parts of the plant can include, but need not be limited to the seed, seed hull, flower, stem, stalk, root, hemp lignin, hemp cellulose, hurd/shive, and/or the like. The hemp material can be hemp fibers and/or hemp compounds derived from the plant. The hemp material can include particles. The size(s) of the particles can range from 1 micron-1000 microns. The shapes of the particles can vary and be one or a combination of spherical, cylindrical, flat, etc. The moisture content of the particles can be 15% or less. In some embodiments, the post hemp material can be further processed, for example, the particles can be further reduced in size or further dried, prior to use in the polymer material.

In some embodiments, the material is derived from post extraction hemp. Post extraction hemp can include any material obtained from or that is a by-product of an extraction process involving hemp as a starting material. For example, the extraction process can be any process typically used to remove valuable biomolecules from the hemp including, for example, cannabinoids, terpenes, flavonoids, and the like. The process can include any derivative concentration methods. Commonly, cannabis extraction procedures involve, but are not limited to flower (aka “nugs” or “buds”) and trim (leaves that are trimmed from the flower before it is cured).

In some embodiments, the polymer material is made from hemp powder. Hemp powder is generally made from a defatted hemp seed cake. When hemp seed is pressed into oil, the co-product of the oil is the defatted hemp seed cake. The hemp seed cake is used to produce a hemp powder by methods such as sifting and milling and/or the like.

In some embodiments, the polymer material is made from hemp hulls. Hemp hulls are the hard outer shell of a whole hemp seed after the seed has been extruded.

In some embodiments, the polymer material can include one or more distinct hemp fibers. The hemp fibers can include one or combinations of core fibers, bast fibers, straw fibers, hull fibers, and/or the like. Core fibers are short, lignocellulose-based fibers occurring within softwood and hardwood trees and other plants with wood-like cores, including hemp. Bast fibers are long, strong lignocellulose-based fibers that occur within a narrow band within the cross section of several plants, including hemp. Straw fibers are primarily found in the stem of the hemp plant and have relatively low strengths compared to the other stem fibers due to high content of weak hemicellulosic substances and thin cell walls with lower cellulose content. Hull fibers are those fibers which remain after the seed-dehearting process.

In some embodiments, the polymer can be made from a hemp material derived from certain compounds present in hemp. The compounds can include one or combinations of different celluloses, lignins, hemicelluloses, pectins, and/or the like. In some embodiments, the polymer includes cellulose, lignin, hemicellulose and pectin. Cellulose comprises long chain polysaccharide molecules of high molecular weight, such as polymeric carbohydrates or sugars. Cellulose molecules are microfibrous at the nanometer scale. Cellulose itself is stiff and of high tensile strength. Cellulose molecules bond with themselves to form spiral-like mesofibrils or supermolecules of cellulose fibers. Lignin is an amorphous, somewhat rigid, high molecular weight polymer of moderate strength that does not form fibrous structures. Lignin occupies spaces between the cellulose mesofibrils and acts as a cellulose fiber binder. Hemicellulose resembles cellulose but its fibers are weaker, shorter, and of lower molecular weight. Some of the hemicellulose is found with lignin and aids in binding the strong cellulose fibers together. Hemicellulose can bond with both cellulose and lignin. The combination of cellulose, lignin and hemicellulose creates a single fiber tube inside which the cell vacuole is housed. This tube is called an ultimate fiber and is the primary building block of the coarser bast fiber, which contains many ultimate fibers. Pectins are weak, gummy, amorphous, polysaccharides of low molecular weight. Pectins combine with lignin to form the middle lamella, a flexible, continuous binder phase that binds the ultimate fibers into flexible discrete bast fibers.

The hemp material can include particles. The size(s) of the particles can range from 1 micron-1000 microns. For example, the size of the particles can be 1 um, 3 um, 10 um, 25 um, 50 um, 75 um, 100 um, 200 um, 300 um, 400 um, 500 um, 750 um or 1000 um. The shapes of the particles can vary and can be one or a combination of substantially spherical, cylindrical, flat, dodecahedral, octahedral, hexahedral (cuboid), tetrahedral, icosahedra., etc. In this context, “substantially” is intended to indicate that that structure would likely be described as corresponding to one of the mentioned shapes, without any requirement or expectation that the particle would have any perfect geometric shape, being the product of formation by biological processes and reduction by mechanical and/or chemical processes. The moisture content of the particles can be 0.25%-15%. For example, the moisture content can be about 0.25%, 0.5%, 1%, 2%, 3%, 4%, 5%, 6%, 7%, 8%, 9%, 10%, 11%, 12%, 13%, 14%, or 15%. In some embodiments, the post hemp material can be further processed, for example, the particles can be further reduced in size or further dried, prior to use in the polymer material.

The hemp material included in the polymer material of the present invention can include one or more or any combination of any of the fibers or molecules of the hemp plant, including but not limited to those described within this application. In some embodiments, the hemp or hemp components can be collected and processed for the purpose of including them in the compounds of the present invention. In some embodiments, the hemp or hemp components can be a waste product or derivative of some other hemp processing activity, including activities where the hemp is used to produce other useful articles or compounds.

In some embodiments, the polymer material includes at least 1% hemp material by weight. In some embodiments, the polymer material can include about 1%-80% hemp material by weight. For example, the polymer material can include about 1%, 5%, 10%, 15%, 20%, 25%, 30%, 33%, 35%, 40%, 50%, 60%, 70%, 80% or more hemp material by weight. The percentages disclosed are the percentage by weight of the total composition.

In some embodiments, the polymer material includes at least 20% vegetable content, in addition to hemp material. For example, the polymer material can include at least about 21%, 22%, 23%, 24%, 25%, 30%, 40%, 50%, 60%, 70%, 80%, 85%, 90%, 95% or 100% vegetable content, inclusive of hemp material. Vegetable content can be defined as content of any material derived from a plant. In some embodiments the polymer material can include resin that is vegetable or fossil-fuel based, and may include other additives which can be vegetable or inorganic material.

In some embodiments, the polymer material is in the form of a pellet. The term “pellet”, as used herein, refers to a non-expanded piece of material (e.g. spherical, ellipsoidal, polyhedral or cylindrical) having an average diameter in the range 0.2 mm up to 10 mm, preferably in the range 0.5 mm up to 5 mm such as, for example, 1 mm, 2 mm, 3 mm, or 4 mm.

In some embodiments, the polymer material is made from a combination of hemp material and one or more thermoplastic resin. The thermoplastic resin can be any suitable resin capable of combination with any amount of plant-derived material including, but not limited to, polypropylene (PP), high-density polyethylene (HDPE), low-density polyethylene (LDPE), linear low-density polyethylene, thermoplastic polyurethane, thermoplastic olefin, thermoplastic elastomer, acrylonitrile butadiene styrene (ABS), high impact polystyrene, polybutyl styrene (PBS) and/or the like.

In other particular embodiments, the thermoplastic polymer is derived from organic material, such as polylactic acid (PLA), polyhydroxyalkanoates (PHA), and/or the like. Resins may also include any polymers derived from plant or vegetable or microbiological materials, such as those derived from soy, sugar cane, corn, and/or from energy reserves of microorganisms. In some embodiments, the compound is comprised entirely of plant-derived material or plant and microbiological materials. In some embodiments, the compound is fully or partially biodegradable. For example, the compound can be at least 50% biodegradable within 12 months under conditions compatible with biodegradation. The term “biodegradable” used herein is intended to denote a material that meets the biodegradability criteria specified in ASTM 6400. In other words, the polymer composition is considered to be biodegradable if, upon exposure to a composting environment, 90% of it disintegrates into particles having an average size of less than 2 mm within twelve weeks, and after six months at least 60% of it has degraded into carbon dioxide and/or water.

Further information on manufacture and use of hemp-based plastics is provided in more detail in copending application number entitled HEMP POLYMER MATERIALS AND METHODS OF MAKING SAME, U.S. application Ser. No. 17/754,269, which is incorporated herein by reference in its entirety.

Embodiments of the invention relates specifically to a hemp plastic material containing at least one additive capable of modifying and/or enhancing a function of the plastic to make it suitable for a given use. Various exemplary types and uses of the enhanced plastic material include but are not limited to: blowmold plastic (e.g., jugs, bottles, thin walled containers and caps); straw plastic (e.g., all-vegetable, renewable, sustainable, 100% compostable with no fossil fuel); film (e.g., for foodservice, packaging, agricultural, medical, etc.); ocean plastic (e.g., ultra green, compounded with ocean plastic for architectural tiles, building materials, composite decking, etc.), nano hemp-graphene plastic (e.g., lowest weight to strength ratio); scratch and mar resistant plastic (e.g., for toys, plates, cups, jars, anything that manufacturers wish to keep shiny); antimicrobial plastic (i.e., reducing the need for preservatives within the contents as the container itself is a hostile environment for the formation of microbial activities); hemp liquid natural resin (e.g., used as a sealcoating, leveraging the tensile strength of the hemp); hemp natural adhesive (e.g., used in bonding wood, building materials, etc.); hemp textile polymer (e.g., for secondary processing into a textile fiber for clothing etc.); 3D printer plastic (for filament extrusion); enhanced biodegradable plastic (e.g., some up to 100% bio material); automotive plastic (e.g., high impact, low weight); aerospace plastic (e.g., low weight, high strength); foodservice plastic, (e.g., FDA compliant, designed for enhanced shelf stability); outdoor/high impact resistant plastic (e.g., high tensile strength, high impact); indoor/paintable plastic (e.g., inexpensive, easily molded for trim, etc.); post-consumer resin (PCR) plastic (e.g., ultra ecological combination of PCR/hemp); and/or the like.

In some embodiments, the invention can be injection moldable, rotomoldable, thermoformable, form extrudable, blow moldable, filament extrudable, and/or the like.

In some embodiments, the characteristics of the polymer material can be reported according to one or more of the following properties. Specific gravity is a ratio of the density of a substance to the density of a reference substance, usually water. Gardner Impact Resistance is measured by a falling weight from a controlled distance. For plastic materials the force is increased until structural failure occurs. The Melt Flow Rate is a measure of the ease of flow of melted plastic and represents a typical index for Quality Control of thermoplastics. Measures of Effectiveness (MOE) are measures designed to correspond to accomplishment of mission objectives and achievement of desired results. They quantify the results to be obtained by a system and may be expressed as probabilities that the system will perform as required. Tensile elongation is a measure of both elastic deformation and plastic deformation, and is commonly expressed as a percentage. Tensile strength is measured by dividing the maximum load sustained by the specimen in newtons (pounds-force) by the average original cross-sectional area in the gage length segment of the specimen in square meters (square inches). IZOD (ISO 180 or ASTM D256) defines a method used in which a pendulum-like swinging weight impacts a notched plastic specimen and is expressed as the amount of further motion of the pendulum after breaking through the specimen.

In some embodiments, a further parameter, the “Hemp Plastic Comparability Quotient” (HPCQ) of a hemp-containing plastic is used to provide a quantitative indication of the comparability, by one or more standard parameters, between characteristics of a hemp-containing plastic (the Hemp Plastic) and a non-hemp-containing, petroleum-based plastic (the Reference Plastic), having an otherwise similar composition and use. For purposes of this disclosure, the HPCQ is defined as the absolute value of the percentage difference of at least one measurable quantitative parameter associated with the performance of a given type of plastic. Where comparison is based upon multiple quantitative performance parameters, the HPCQ is the average of two or more such parameters, where the parameters used in the comparison, are chosen based upon being (a) quantitative and (b) associated with the performance of a given type of plastic. In some embodiments of the invention, the HPCQ is no more than 5× the percentage of hemp or hemp-derived materials found in the hemp-based plastic. In other embodiments, the HPCQ is 4×, 3.5×, 3×, 2.5×, 2.0×, 1.5×, 1.0×, 0.75×, 0.5×, 0.25×, 0.1× or 0.05× the weight percentage of hemp or hemp-derived materials in the plastic product being scored. For illustration purposes, if the performance of a given composition of plastic for a given use were generally regarded as a function of its tensile strength, the HPCQ would be calculated as follows:
Tensile strength of Hemp Plastic: 100
Tensile strength of Reference Plastic: 110
Weight percent of hemp material in Hemp Plastic: 5%

$$HPCQ = [ 110 - 100 ] / 5 = 10 / 5 = 2$$

### Methods of Making Hemp-Based Polymers

Some embodiments of the invention relate to methods of producing hemp-based polymer compounds made from hemp described herein.

In some embodiments, the hemp is first processed to extract portions for commercial use, such as CBD oil or terpenes, and the product is used to make the hemp-based polymer material. In embodiments where additional commercial products are extracted from the hemp, the hemp provided for the creation of the present invention can include portions of the hemp plant not otherwise useful for commercial exploitation or those portions of the hemp plant left behind following the first processing.

Extraction processes can include liquid solvent extraction, oil solvent extraction, CO2 extraction, ice water extraction, and/or the like.

In some embodiments, the hemp is grown and harvested for use in creation of the compounds of the present invention, or for any other known commercial purpose. In some embodiments, the hemp is provided directly for processing into the compound of the present invention.

In some embodiments, the hemp is subject to a drying process, whereby the moisture content of the hemp or other hemp material is reduced to about 20%, 15%, 10%, 7%, 1%, 0.25% or less. The hemp can be tested to ensure that moisture content and humidity are appropriate to continue the process, as well as to ensure the hemp is free of mold or other contaminants. Once approved, the hemp can be ground into a powder. The hemp can be ground into various sizes, and specific portions of the hemp plant can be ground to differing sizes. In some embodiments, the hemp can be ground into a powder, where the milling size is between 1000 and 5000 microns. For example, the milling size can be about 1000, 2000, 3000, 4000, or 5000 microns. The hemp can come in various shapes and may or may not be uniformly ground. The hemp material can be combined with at least one other polymer. This typically occurs after the milled hemp has been further ground to a powder having particle sizes from 1 micron to 1000 microns, as described and quantified herein. The hemp material and at least one other polymer can be compounded by extrusion technology. Extrusion technology can include mixing, melting and extruding. In some embodiments, the extrusion of the hemp and the polymer results in a pellet. Extruding techniques can include use of an extruder such as a co rotating twin extruder, a continuous mixture extruder, and/or any other compounding extruding equipment.

In some embodiments, a first hemp powder can be combined with one or more other hemp powders as well as other plant, microbial, organic, and/or inorganic material.

The specific combination of hemp material and polymers can be varied to achieve desired characteristics in the final compound, such as wall thickness, tensile strength, flexibility, and more. Further, additional bonding agents, strand building polymer additives and other elastomers can be added during the creation of the compound of the present invention to achieve desired characteristics. The components can be combined in a chemical mixing auger under time, heat, temperature, pressure, and other conditions which create the desired characteristics of the compound.

In some embodiments, the compound of the invention is pelletized for later use in injection molding. In some embodiments, the compound of the invention is provided in a sheet suitable for thermoforming. Said sheets may be suitable for thin-gauge or thick-gauge thermoforming as desired. In some embodiments, the sheets are suitable for vacuum forming. In some embodiments, the compound of the present invention is provided in a form suitable for other known plastic processing and forming methods.

The conditions under which the compound is created can be altered to achieve desired traits in the final compound. In some embodiments, the compound can then be paired with a range of color agents, chemical property enhancers, natural enhancing elements, additives, or biodegrading enhancers. In particular embodiments, the polymer is combined with chitosan or other antimicrobial components, including but not limited to other crustacean-derived compounds, to create an environment hostile to microbial activity, thereby creating a polymer exhibiting anti-microbial characteristics. Anti-microbial additives are addressed in more detail in copending application entitled ANTIMICROBIAL HEMP POLYMER MATERIALS AND METHODS OF MAKING SAME, U.S. Application Ser. No. 17/754,293, which is incorporated herein by reference in its entirety.

Further information related to the invention can be found in U.S. patent application Ser. No. 15/562,717, filed Apr. 1, 2016, entitled COMPOSITE MATERIALS COMPRISING AT LEAST ONE THERMOPLASTIC RESIN AND GRANULAR SHIVE FROM HEMP AND/OR FLAX (now U.S. Pat. No. 10,450,429), which is incorporated herein by reference in its entirety.

### Exemplary Components of Various Hemp Plastics

The plastics of embodiments of the invention comprise at least one hemp-based or hemp-derived ingredient (collectively, a hemp material) combined with at least one other ingredient. In some embodiments, the composition of the plastic is a combination of a hemp material and a thermoplastic polymer resin. In some embodiments, the thermoplastic polymer resin is petroleum-derived, while in some embodiments, the thermoplastic polymer resin is a resin that is bio-based, biodegradable, or a recycled plastic.

### Plastics

### Petroleum-Based Resins

Acrylonitrile Butadiene Styrene
Low Density Polyethylene
High Density Polyethylene
High Impact Polystyrene
Polystyrene copolymer
Polypropylene
Propylene copolymers
Polyether-based thermoplastic polyurethane

### Bio-Based, Biodegradable, and Recycled Plastics

Recycled polypropylene copolymers
Green HDPE
Biodegradable Polyester
Ingeo biopolymer 3001D
Bio-based polybutylene succinate (PBS)
Bio-based polylactic acid
Polyhydroxyalkanoates

### Additives

The plastics of the invention further comprise one or more additives that enhance one or more functions or characteristics of the plastic. There are numerous such additives known to those of skill in the art, and such additives are capable of modifying the properties of a hemp plastic according to the following non-limiting exemplary list.

### Antioxidants

6AA01-3, AMFINE ADK A-612

### UV Stabilizers

CYASORB UV3808PP5

### Colorants

6AB5 (black colorant)

### Polymer Compatibilizers and Impact Modifiers

Dow AMPLIFY GR216
Dow Engage 8150 Dow Chemical Company

### Mold Releasers, Scuff Resisters, Friction Reducers, Torque Releasers

Croda Incroslip-G CRODA

### Polymer Coupling Agents and Process-Temperature Lubricants

Struktol TRO71 Struktol

### Enhancers of Resistance to Acid and Base, Density Enhancers

BARIUM SULPHATE

### Functional Fillers (to Enhance Stiffness and Dimensional Stability)

Talc Imifabi HTPultra 10C IMIFABI

### Miscellaneous Polymer Modifiers

Techmer PM116180 Techmer Poly Modifiers
Techmer PM116182 Techmer Poly Modifiers
Techmer PM116183 Techmer Poly Modifiers
Techmer PM18966 Techmer Poly Modifiers
Techmer PPM 116181 Techmer Poly Modifiers
Techmer PPM 116227 Techmer Poly Modifiers

### Odor Maskers

Struktol RP17 STRUKOL Company of America
Struktol RP53 STRUKOL Company of America

Properties conferred upon hemp plastics of the invention by various additives include: antiblock; antifog; antimicrobial; antioxidant; antistat; antiwarp; clarification; colorant; conductivity promotion; conductivity reduction; cycle time reduction; density enhancement; density reduction; dimensional stability enhancement; flame retardation; foaming promotion; foaming reduction; friction promotion; friction reduction; heat stabilization; hydrophobicity enhancement; hydrophobicity reduction; impact modification; IR absorption; IR reflection; laser marking; mold release; nucleation; odor masking; optical brightening; polymer compatibility; polymer coupling; polymer processing enhancement; process-temperature lubrication; purge promotion; release promotion; resistance to acid and base; scent modification; scuff resistance; slip modification; stiffness enhancement; torque release; tracing; UV blocking; UV inhibition; UV stabilization; vapor corrosion inhibition, and the like.

### EXAMPLES

### Example 1—Injection Molding and Parameters

Embodiments of the invention were prepared for use in injection molding. For injection molding, while these settings can be varied, typical settings were as set forth below.

### Mold Location Temperatures (Fahrenheit)

Back 270-330
Middle 300-340
Front 300-340
Nozzle 310-370
Mold 80-100

### Pressures

Injection Moderate
Hold Moderate-High
Back Moderate

### Other

Injection Rate Moderate
Screw Speed Moderate—Fast
Gate Size >0.06 inches

### Barrel Temps:

Zones 1-5: 170° C.
Zones 6-8: 160° C.

### Pelletizer:

Adapter temp: 230° C.
PDV temp: 160° C.
Die temp: 220° C.
Water temp: 45° C.
Pelletizer Speed: 2300 RPM

### Example 2—Use of Antioxidants in Hemp Plastic Formulations

Many formulations can benefit from presence of an antioxidant such as, for example, Amfine ADK A-612 and/or Struktol TR071. Plastic formulations were made combining hemp material and a thermoplastic polymer, with an antioxidant additive in a range between 0.75% and 1.5%.

Properties of an exemplary formulation comprising ABS, antioxidant, and 25% hemp material were as follows:

| | |
|---|---|
| SG [g/cc] | 1.0775 |
| Gardner Impact | 12 |
| [ft*lbs] | |
| MFI [g/10 min] | 33.1 |
| MOE [PSI] D790 | 281000 |
| TE Auto [%] D638 | 2.82 |
| Yield [PSI] D638 | 2309 |
| IZOD [ft-lbs/in] | 0.515 |

### Example 3—Use of UV Stabilizers in Hemp Plastic Formulations

Formulations were made containing a UV stabilizer such as, for example, CYASORB UV3808PP5. Plastic formulations were made combining hemp material and a thermoplastic polymer, with a UV stabilizer additive in a range between 0.25% and 1.0%.

Properties of an exemplary formulation comprising polypropylene, UV stabilizer, and 20% hemp material were as follows:

| | |
|---|---|
| SG [g/cc] | 0.95 |
| Gardner Impact | 12 |
| [ft*lbs] | |
| MFI [g/10 min] | 41 |
| MOE [PSI] D790 | 140800 |
| TE Auto [%] D638 | 13.1 |
| Yield [PSI] D638 | 2555 |
| IZOD [ft-lbs/in] | 0.735 |

### Example 4—Use of Colorants in Hemp Plastic Formulations

Formulations were made containing a colorant such as, for example, a black colorant. Plastic formulations were made combining hemp material and a thermoplastic polymer, with a black colorant additive in a range between 0.25% and 0.5%.

Properties of an exemplary formulation comprising polypropylene, black colorant, and 25% hemp material were as follows:

| | |
|---|---|
| SG [g/cc] | 0.9827 |
| Gardner Impact [ft*lbs] | 32 |
| MFI [g/10 min] | 20.85 |
| MOE [PSI] D790 | 160300 |
| TE Auto [%] D638 | 10.93 |
| Yield [PSI] D638 | 2059 |
| IZOD [ft-lbs/in] | 1.473 |
| HDT ASTM D624, | 89.1 C. |
| 0.45 MPa | |

### Example 5—Use of Polymer Compatibilizers and Impact Modifiers in Hemp Plastic Formulations

Formulations were made containing an additive effective as a polymer compatibilizer and an impact modifier such as, for example, Dow Amplify GR216 and/or Dow Engage 8150. Plastic formulations were made combining hemp material and a thermoplastic polymer, with a polymer compatibilizer and an impact modifier additive in a range between 3% and 12%.

Properties of an exemplary formulation comprising polypropylene, a polymer compatibilizer and an impact modifier additive, and 25% hemp material were as follows:

| | |
|---|---|
| SG [g/cc] | 0.9771 |
| Gardner Impact | 48 |
| [ft*lbs] | |
| MFI [g/10 min] | 14.24 |
| MOE [PSI] D790 | 144300 |
| TE Auto [%] D638 | 22.9 |
| Yield [PSI] D638 | 1702 |
| IZOD [ft-lbs/in] | 3.25 |

### Example 6—Use of Mold Releasers, Scuff Resisters, Friction Reducers, and Torque Releasers in Hemp Plastic Formulations

Formulations were made containing an additive effective as a mold releaser, scuff resister, friction reducer, and torque releaser such as, for example, Croda Incroslip-G. Plastic formulations were made combining hemp material and a thermoplastic polymer, with a mold releaser, scuff resister, friction reducer, and torque releaser additive in a range between 0.3% and 1.0%.

Properties of an exemplary formulation comprising polybutylene succinate (PBS); a thermoplastic polymer, with a mold releaser, scuff resister, friction reducer, and torque releaser additive; and 25% hemp material were as follows:

| | |
|---|---|
| SG [g/cc] | 1.2924 |
| Gardner Impact | 8 |
| [ft*lbs] | |
| MFI [g/10 min] | 34.3 |
| MOE [PSI] D790 | 197000 |
| TE Auto [%] D638 | 5.16 |
| Yield [PSI] D638 | 4319 |
| IZOD [ft-lbs/in] | 0.803 |

### Example 7—Use of Polymer Coupling Agents and Process-Temperature Lubricants in Hemp Plastic Formulations

Formulations were made containing a polymer coupling agent and process-temperature lubricant such as, for example, Struktol TR071. Plastic formulations were made combining hemp material and a thermoplastic polymer, with a polymer coupling agent and process-temperature lubricant additive in a range between 0.5% and 2.0%.

Properties of an exemplary formulation comprising high density polyethylene, polymer coupling agent and process-temperature lubricant, and 33% hemp material were as follows:

| | |
|---|---|
| SG [g/cc] | 1.02 |
| Gardner Impact | 28 |
| [ft*lbs] | |
| MFI [g/10 min] | 12 |
| MOE [PSI] D790 | 87200 |
| TE Auto [%] D638 | 34.5 |
| Yield [PSI] D638 | 1537 |
| IZOD [ft-lbs/in] | 1.593 |

### Example 8—Use of Enhancers of Resistance to Acid and Base, and Density Enhancers in Hemp Plastic Formulations

Formulations were made containing an additive to enhancer of resistance to acid and base, and density enhancer such as, for example, barium sulfate. Plastic formulations were made combining hemp material and a thermoplastic polymer, with an enhancer of resistance to acid and base, and density enhancer such as additive in a range between 12% and 35%.

Properties of an exemplary formulation comprising polypropylene, an enhancer of resistance to acid and base, and density enhancer, and 25% hemp material were as follows:

| | |
|---|---|
| SG [g/cc] | 1.2300 |
| Gardner Impact | 20 |
| [ft*lbs] | |
| MFI [g/10 min] | 17.7 |
| MOE [PSI] D790 | 185100 |
| TE Auto [%] D638 | 4.3 |
| Yield [PSI] D638 | 1597 |
| IZOD [ft-lbs/in] | 1.105 |

### Example 9—Use of Functional Fillers to Enhance Stiffness and Dimensional Stability in Hemp Plastic Formulations

Formulations were made containing a functional filler to enhance stiffness and dimensional stability such as, for example, talc (Imifabi HTPultra 10C). Plastic formulations were made combining hemp material and a thermoplastic polymer, with a functional filler to enhance stiffness and dimensional stability additive in a range between 3% and 8%.

Properties of an exemplary formulation comprising polypropylene, a functional filler to enhance stiffness and dimensional stability additive, and 25% hemp material were as follows:

| | |
|---|---|
| SG [g/cc] | 0.9972 |
| Gardner Impact | 36 |
| [ft*lbs] | |
| MFI [g/10 min] | 1.544 |
| MOE [PSI] D790 | 241000 |
| TE Auto [%] D638 | 31.7 |
| Yield [PSI] D638 | 2595 |
| IZOD [ft-lbs/in] | 2.172 |

### Example 10—Use of Odor Maskers in Hemp Plastic Formulations

Formulations were made containing an odor masker such as, for example, Struktol RP17 and/or Struktol RP53. Plastic formulations were made combining hemp material and a thermoplastic polymer, with an odor master additive in a range between 1.5% and 6%.

Properties of an exemplary formulation comprising polypropylene, an odor masker, and 25% hemp material were as follows:

| | |
|---|---|
| SG [g/cc] | 0.9874 |
| Gardner Impact [ft* lbs] | 28 |
| MFI [g/10 min] | 20.2 |
| MOE [PSI] D790 | 161300 |
| TE Auto [%] D638 | 10.2 |
| Yield [PSI] D638 | 1864 |
| IZOD [ft-lbs/in] | 1.864 |

The various methods and techniques described above provide a number of ways to carry out the application. Of course, it is to be understood that not necessarily all objectives or advantages described are achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some embodiments specifically include one, another, or several features, while others specifically exclude one, another, or several features, while still others mitigate a particular feature by including one, another, or several other features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

In some embodiments, any numbers expressing quantities of ingredients, properties such as molecular weight, reaction conditions, and so forth, used to describe and claim certain embodiments of the disclosure are to be understood as being modified in some instances by the term “about.” Accordingly, in some embodiments, the numerical parameters set forth in the written description and any included claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are usually reported as precisely as practicable.

In some embodiments, the terms “a” and “an” and “the” and similar references used in the context of describing a particular embodiment of the application (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application.

Variations on preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

1. A hemp-based plastic composition comprising 10%-40% particulate hemp material combined with a thermoplastic polymeric material and at least one additive selected to confer or enhance a property of the plastic.

2. The hemp-based plastic composition of claim 1 wherein the property is at least one of: antiblock; antifog; antimicrobial; antioxidant; antistat; antiwarp; clarification; colorant; conductivity promotion; conductivity reduction; cycle time reduction; density enhancement; density reduction; dimensional stability enhancement; flame retardation; foaming promotion; foaming reduction; friction promotion; friction reduction; heat stabilization; hydrophobicity enhancement; hydrophobicity reduction; impact modification; IR absorption; IR reflection; laser marking; mold release; nucleation; odor masking; optical brightening; polymer compatibility; polymer coupling; polymer processing enhancement; process-temperature lubrication; purge promotion; release promotion; resistance to acid and base; scent modification; scuff resistance; slip modification; stiffness enhancement; torque release; tracing; UV blocking; UV inhibition; UV stabilization; and vapor corrosion inhibition.

3. The hemp-based plastic composition of claim 1 wherein the hemp material is derived from one or more of parts of a hemp plant selected from the group consisting of seed, seed hull, seed powder, flower, stem, stalk, root, lignin, cellulose, and shive/hurd.

4. The hemp-based plastic composition of claim 1 the particulate material comprising particles between 1 micron and 1000 microns in size.

5. The hemp-based plastic composition of claim 1, the hemp material having a moisture content between 0.25% and 15%.

6. The hemp-based plastic composition of claim 1 wherein the thermoplastic polymeric material is derived from a plant, animal or bacterium.

7. The hemp-based plastic composition of claim 1 wherein the thermoplastic polymeric material is a thermoplastic resin.

8. The hemp-based composition of claim 7 wherein the thermoplastic resin is selected from polypropylene, polyethylene, acrylonitrile butadiene styrene.

9. The hemp-based plastic composition of claim 1 wherein the composition is in the form of a pellet or a sheet.

10. The hemp-based plastic composition of claim 1 wherein the composition is adapted to be suitable for at least one use selected from: injection-molded plastic; rotomold plastic; thermoformed plastic; form-extruded, blowmold plastic; straw plastic; film; nano hemp-graphene plastic; scratch and mar resistant plastic; antimicrobial plastic; hemp liquid natural resin; hemp natural adhesive; hemp textile polymer; 3D printer plastic; filament-extruded; enhanced biodegradable plastic; automotive plastic; aerospace plastic; foodservice plastic; outdoor/high impact resistant plastic; indoor/paintable plastic; and post-consumer resin plastic, and wherein the at least one additive enhances said suitability.

11. The hemp-based plastic composition of claim 1 having a Hemp Plastic Comparability Quotient (HPCQ) of less than 3.

12. The hemp-based plastic composition of claim 11 having a HPCQ of less than 1.

13. The hemp-based plastic composition of claim 11, wherein the HPCQ is based on at least one of: Gardner impact resistance; melt flow rate; tensile elongation; tensile strength; density/specific gravity; melt mass-flow rate; molding shrinkage; flexural modulus; flexural strength; notched IZOD impact; Rockwell hardness; deflection temperature under load; and flame rating.

14. A method of making the composition of claim 1 comprising:
combining a hemp material with a thermoplastic polymeric material and at least one additive, to create a polymeric base composition such that 10-40% of the composition is hemp material;
exposing the base composition to conditions selected from at least two of elevated heat; elevated pressure; combination with a fourth material; a molding, injecting, layering or extruding process, and a finishing process; and
recovering the hemp-based plastic composition of claim 1.
